(19) United States
(12) Patent Application Publication
(10) Pub. No.: US 2009/0160938 A1
(43) Pub. Date: Jun. 25, 2009

(54) Image Processing Method and Image Capture Apparatus Applying The Same

(76) Inventors: Parn-Far Chen, Hsinchu City (CN); Fei-Jen Teng, Hsinchu City (TW); Ming-Chun Ma, Hsinchu City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/342,255

(22) Filed: Dec. 23, 2008

(30) Foreign Application Priority Data
Dec. 25, 2007 (TW) 096150050

(51) Int. Cl. H04N 7/18; H04N 5/228; H04N 5/235; H04N 5/202; H04N 9/68

(52) U.S. Cl. 348/148; 348/222.1; 348/229.1; 348/254; 348/234; 348/E05.031; 348/E05.034; 348/E05.074; 348/E09.053; 348/E07.085

(57) ABSTRACT

An image processing method and an image capture apparatus applying the method are disclosed. The image processing method comprises the steps of: capturing an image; detecting whether the image is captured in a low luminance environment; performing at least one image enhanced process for the image when the image is captured in the low luminance environment, so as to obtain a processed image; and outputting the processed image.

### BACKGROUND OF THE INVENTION

1. Field of the Invention

The present invention relates to an image processing method, and, more particularly, to an image processing method capable of improving output quality of the image captured in a low luminance environment.

2. Description of the Related Art

Generally, the light is not bright enough in a low luminance environment. When an image capture apparatus in this environment is used for capturing an image via a sensor (such as a CCD or a CMOS) and then output said image, its image quality is usually worse than the image quality of the image captured in normal luminance environment and hard to recognize the object in the image. In order to solve this problem, a special process is usually performed to the image captured in the low luminance environment; for example, by extending the exposure time or adjusting the gain value of the image to improve the image quality and the recognizability of the image. However, for some image capture apparatus, their predetermined image output refresh rate is limited to be lower than a specific lever (such as 30FPS). Therefore, the extendable exposure time for the image is also limited and the gain value also has a maximum adjustment value, and the image cannot be adjusted more if both the exposure time and the gain value have reached of maximum value. Accordingly, the image quality and the recognizability of the image cannot be improved with the image processes.

Therefore, it is desirable to provide an image processing method being capable of improving the image quality of the image captured in a low luminance environment to mitigate and/or obviate the aforementioned problems.

### SUMMARY OF THE INVENTION

A main objective of the present invention is to provide an image processing method capable of improving image quality of the image captured in a low luminance environment.

In order to achieve the above mentioned objective, the image processing method of the present invention comprises the steps of: capturing an image; detecting whether the image is captured in a low luminance environment; performing at least one image enhanced process for the image when the image is captured in the low luminance environment, so as to obtain a processed image; and outputting the processed image. The image processing method of the present invention can improve the image quality and the recognizability of the image captured in the low luminance environment and maintain the image quality of the image captured in the normal luminance environment

The image capture apparatus of the present invention comprises a capturing module, a detecting module, a processing module and an output module. Each module is electrically connected with each other. The capturing module is used for capturing an image; the detecting module is used for detecting whether the image is captured in a low luminance environment; the processing module is used for the image performing at least one image enhanced process when the image is captured in the low luminance environment, so as to obtain a processed image; and the output module is used for outputting the processed image. The image capture apparatus of the present invention can detect the image captured in the low luminance environment and perform the image process for it by applying the aforementioned image processing methods to improve the image quality and the noise of the output image.

Other objects, advantages, and novel features of the invention will become more apparent from the following detailed description when taken in conjunction with the accompanying drawings.

### BRIEF DESCRIPTION OF THE DRAWINGS

FIG. 1 is a schematic drawing of an image capture apparatus according to the present invention.

FIG. 2 is a main flowchart of an image processing method according to the present invention.

FIG. 3 is an operating flowchart of an embodiment of the image processing method according to the present invention.

FIG. 4 is a predetermined Gamma drawing of the image processing method according to the present invention.

### DETAILED DESCRIPTION OF THE PREFERRED EMBODIMENT

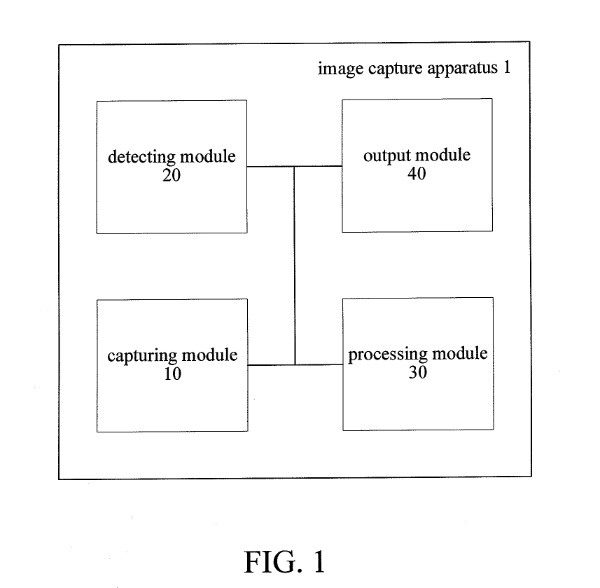

Please refer to FIG. 1. FIG. 1 is a schematic drawing of an image capture apparatus according to the present invention. As shown in FIG. 1, an image capture apparatus 1 comprises a capturing module 10, a detecting module 20, a processing module 30, and an output module 40. Each module is electrically connected with each other. The capturing module 10 is used for capturing an image; the detecting module 20 is used for detecting whether the image is captured in a low luminance environment; the processing module 30 is used for performing at least one image enhanced process for the image when the image is captured in the low luminance environment, so as to obtain a processed image; and the output module 40 is used for outputting the processed image. In one embodiment of the present invention, the capturing module 10, the detecting module 20, the processing module 30, and the output module 40 can be software program, hardware, firmware, electrical circuit or the combination. The image capture apparatus 1 performs some other the image enhanced processes through the processing module 30 to improve quality and recognizability of the image captured in the low luminance environment. So it may make up for the limited exposure time and gain value of the image due to the limitation of the low image output refresh rate of the image capture apparatus 1. In this embodiment, the capturing module 10 is an image sensor such as a CCD or a CMOS, or other equivalent device. Furthermore, the image capture apparatus 1 can be used for an external image monitor of a vehicle, or the image capture apparatus with low image output refresh rate in the other low luminance environment, such as an internal monitor for a machine or a security system monitor for dark environment.

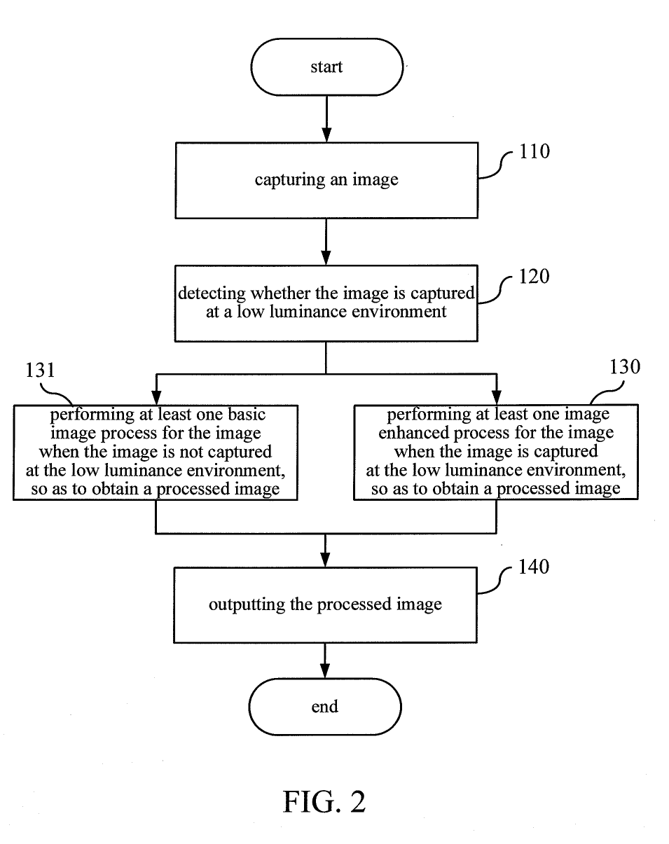

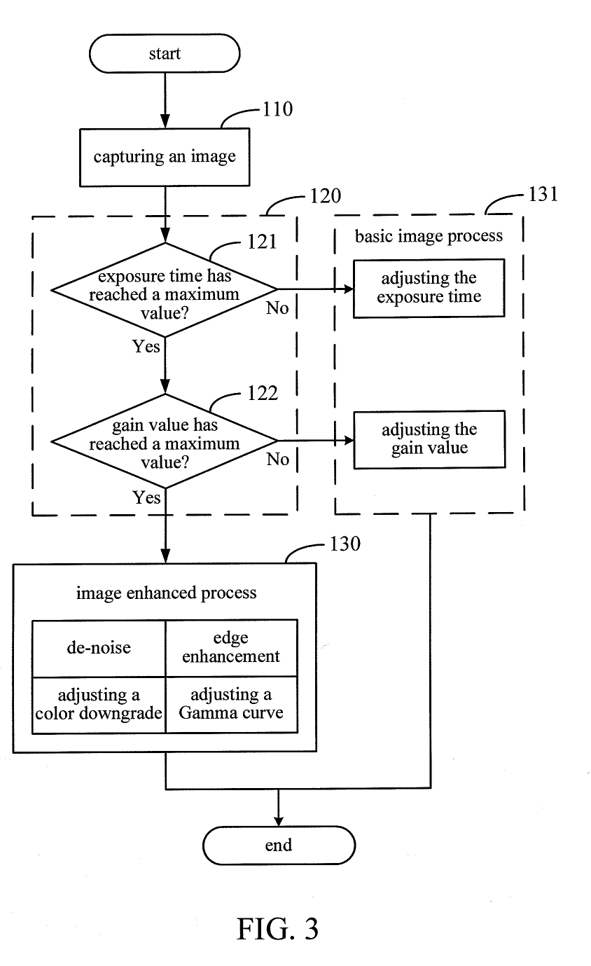

Please refer to FIG. 2 and FIG. 3 together. FIG. 2 is a main flowchart of an image processing method according to the present invention. FIG. 3 is an operating flowchart of an embodiment of the image processing method according to the present invention. Moreover, the following image processing method of the present invention can be applied onto the image capture apparatus 1 shown on FIG. 1 or any other the image capture apparatuses. As shown in FIG. 2. and FIG. 3, the image processing method is explained in following description.

Step 110: capturing an image. As shown in FIG. 1, a user can capture an image through the capturing module 10 of the image capture apparatus 1. Furthermore, the capturing module 10 is an image sensor.

Step 120: detecting whether the image is captured in a low luminance environment. As shown in FIG. 1, the image obtained from step 110 is analyzed and detected by the detecting module 20 to determine whether the image is captured in a low luminance environment.

In one embodiment of the present invention, step 120 further comprises step 121: determining whether an exposure time of the image has reached a maximum value so the exposure time needs to be adjusted. As shown in FIG. 1 and FIG. 3, the exposure time of the image is detected by the detecting module 20. If the exposure time of the image has not reached the maximum value, then the image might be captured in a normal luminance environment. On contrary, if the exposure time of the image has reached the maximum value, then the image might be captured in the low luminance environment.

If the exposure time of the image has reached to the maximum value in step 121, step 122 is performed: determining whether a gain value of the image has reached the maximum value so the gain value needs to be adjusted. As shown in FIG. 1 and FIG. 3, the gain value of the image is detected by the detecting module 20. If the gain value of the image has not reached the maximum value, then the image might be captured in a normal luminance environment. On contrary, if the gain value of the image has reached the maximum value, then the image might be captured in the low luminance environment.

The exposure time and the gain value of the image can be adjusted by the image capture apparatus 1 according to different environment conditions to ensure the output quality of the image. However, when the limitation of the image output refresh rate of the image capture apparatus 1 is too low (such as 30FPS), and the image is captured in the low luminance environment, the exposure time and the gain value of the captured image often has reached the maximum value but still not able to improve the quality of the image. With step 121 and step 122 detecting the exposure time and the gain value of the image, the image can be determined whether it is captured in the low luminance environment. Moreover, step 121 and step 122 can be performed in a reverse sequence.

After step 120, step 130 is performed: performing at least one image enhanced process for the image when the image is captured in the low luminance environment, so as to obtain a processed image. As shown in FIG. 1, when the image is identified as being captured in the low luminance environment in the previous steps, at least one image enhanced process may be performed to the image by the processing module 30 to obtain the processed image with improving the quality and the recognizability of the image. Wherein the image enhanced process comprises a de-noise procedure, an edge enhancement procedure, a color downgrade adjustment, and a Gamma curve adjustment. When the image needs to be processed, a single or plurality of image enhanced processes might be performed to the image base on the environment conditions and different the capturing modules 10 of the image capture apparatus 1. Furthermore, a predetermined parameter value can be preset for each previous image enhanced process and pre-loaded into the image capture apparatus 1; when any one of the image enhanced processes needs to be performed, the corresponding predetermined parameter value can be executed to achieve the predetermined image affect.

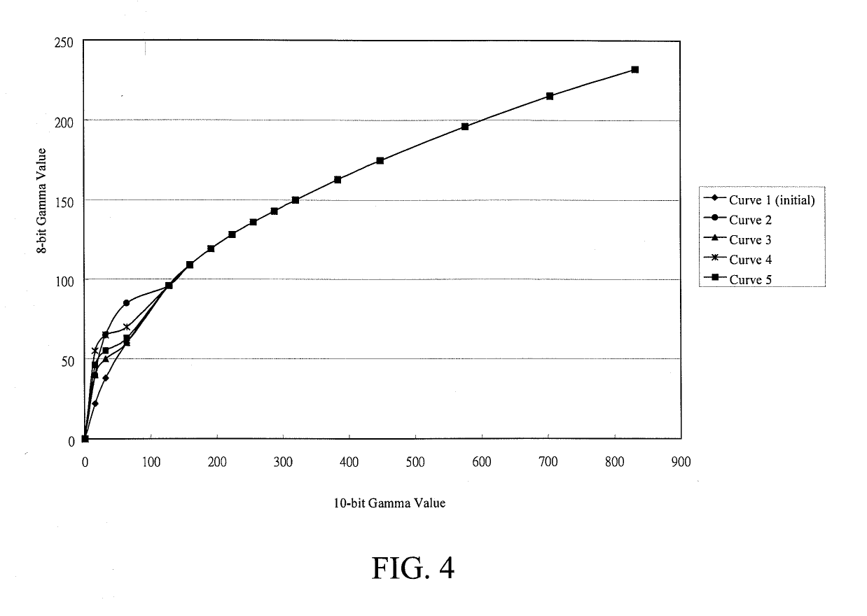

Moreover, please refer to FIG. 4. FIG. 4 is a predetermined Gamma curve drawing of the image processing method according to the present invention. In this embodiment, the Gamma curve of the image enhanced process is predetermined. Since the image captured in the low luminance environment is dark and has low recognizability, the dark area of the Gamma curve of the image is adjusted but not the other area. With this design, the recognizability of the dark area of the image can be improved without effecting the original bright area of the image. As shown in FIG. 4, X axis indicates 10-bit Gamma value, and Y axis indicates 8-bit Gamma value; curve 1 is an initial curve of the image; and curve 2 to curve 5 are the predetermined curves for improving the recognizability of the dark area of the image.

After step 120, step 131 is performed: when the image is not captured in a low luminance environment, at least one basic image process is performed to the image, so as to obtain a processed image. If the previous steps identify the image is not captured in the low luminance environment, which indicates the image must have a specific level of image quality and recognizability. According to different settings or requirements of the image capture apparatus 1, at least one basic image process is performed to the image by the processing module 30 to obtain the processed image with better output quality. The basic image processes include adjusting the exposure time and the gain value of the image. Therefore, the image captured in the normal luminance environment can maintain a better status of the image.

Last, step 140 is performed: outputting the processed image. As shown in FIG. 1, the output module 40 outputs the processed image which is processed by the processing module 30 in step 130 or step 131.

With the previous steps, the image processing method of the present invention can detect the surrounding environment to apply different the image processes to improve the recognizability and the quality of the image, by improving the image captured in the low luminance environment and maintaining the quality of the image captured in the normal luminance environment.

Although the present invention has been explained in relation to its preferred embodiment, it is to be understood that many other possible modifications and variations can be made without departing from the spirit and scope of the invention as hereinafter claimed.

What is claimed is:

1. An image processing method for being applied to an image capture apparatus in a low luminance environment, the method comprising the steps of
(a) capturing an image;
(b) detecting whether the image is captured in a low luminance environment;
(c) performing at least one image enhanced process for the image when the image is captured in the low luminance environment, so as to obtain a processed image; and
(d) outputting the processed image.

2. The method as claimed in claim 1, wherein step (b) further comprises:
determining whether an exposure time of the image has reached a maximum value.

3. The method as claimed in claim 1, wherein step (b) further comprises:
determining whether a gain value of the image has reached a maximum value.

4. The method as claimed in claim 1, wherein when the image is not captured in the low luminance environment, at least one basic image process is performed for the image.

5. The method as claimed in claim 4, wherein the basic image process includes adjusting the exposure time of the image.

6. The method as claimed in claim 4, wherein the basic image process includes adjusting the gain value of the image.

7. The method as claimed in claim 1, wherein the image enhanced process includes a de-noise procedure.

8. The method as claimed in claim 1, wherein the image enhanced process includes an edge enhancement procedure.

9. The method as claimed in claim 1, wherein the image enhanced process includes adjusting a color downgrade of the image.

10. The method as claimed in claim 1, wherein the image enhanced process includes adjusting a Gamma curve of the image.

11. The method as claimed in claim 10, wherein a dark area of the Gamma curve may be adjusted.

12. The method as claimed in claim 1, wherein a predetermined parameter value is set for the image enhanced process.

13. An image capture apparatus comprising:
a capturing module, for capturing an image;
a detecting module, for detecting whether the image is captured in a low luminance environment;
a processing module, for performing at least one image enhanced process for the image when the image is captured in the low luminance environment, so as to obtain a processed image; and
an output module, for outputting the processed image.

14. The apparatus as claimed in claim 13, wherein the image capture apparatus is an external image monitor of a vehicle, a security system monitor or an internal monitor of a machine.

15. The apparatus as claimed in claim 13, wherein at least one basic image process is performed via the processing module for the image when the image is not captured in the low luminance environment.

16. The apparatus as claimed in claim 15, wherein the basic image process includes adjusting an exposure time of the image, or adjusting a gain value of the image.

17. The apparatus as claimed in claim 13, wherein the image enhanced process includes a de-noise procedure, an edge enhancement procedure, adjusting a color downgrade of the image, or adjusting a Gamma curve of the image.
